(19) United States
(12) Patent Application Publication
(10) Pub. No.: US 2010/0282702 A1
(43) Pub. Date: Nov. 11, 2010

(54) CRANE

(76) Inventor: Johannes STEINDL, Elsbethen (AT)

Correspondence Address: WENDEROTH, LIND & PONACK, L.L.P., 1030 15th Street, N.W.,, Suite 400 East, Washington, DC, 20005-1503, US

(21) Appl. No.: 12/772,318

(22) Filed: May 3, 2010

(30) Foreign Application Priority Data
May 7, 2009 (AT) A 691/2009

(51) Int. Cl. B66C 23/68; B66C 23/687

(52) U.S. Cl. 212/349; 212/347

(57) ABSTRACT

A crane, in particular a vehicle crane, comprising a first crane arm and at least one second crane arm which are connected together by way of a joint and which are pivotable relative to each other by way of a drive having a piston-cylinder unit, in each case starting from one of the two end positions in which the crane arms are in substantially mutually parallel relationship until reaching a dead point when the longitudinal axis of the piston-cylinder unit is substantially on a line with the joint, wherein there is provided at least one further drive by which it is possible to go beyond the dead point position of the piston-cylinder unit relative to the joint.

The invention concerns a crane, in particular a vehicle crane, comprising a first crane arm and at least one second crane arm which are connected together by way of a joint and which are pivotable relative to each other by way of a drive having a piston-cylinder unit, in each case starting from one of the two end positions in which the crane arms are in substantially mutually parallel relationship until reaching a dead point when the longitudinal axis of the piston-cylinder unit is substantially on a line with the joint.

A conventional method of overcoming the dead point position of a piston-cylinder unit relative to the joint is that in which the crane arms are pressed with their load pick-up means against the ground there beneath. The torque which occurs in that case in relation to the joint moves the piston-cylinder unit beyond the dead point and the crane can be folded together. That method is extremely inexpensive as no additional material expenditure is necessary. The disadvantage of that method is that the operation of folding the crane together is relatively time-consuming and takes up a great deal of space as the crane arms—strictly speaking the load pick-up means—must make ground contact while the two crane arms are opened out. Often such cranes are so designed that the drive has not just one piston-cylinder unit but for example two piston-cylinder units which are disposed in parallel are used, which acting symmetrically in the same direction move the two crane arms relative to each other. In that case the dead point of the two piston-cylinder units occurs at the same position of the joint, and the movement for going beyond the dead point position has to be effected in the same fashion as just described.

DE 69 16 283 discloses a rotary joint arrangement for folding booms, having an intermediate member between the two crane arms and two stroke cylinders mounted to the crane arms and the intermediate member. The overall pivotal angle is increased by one stroke cylinder implementing a pivotal range of about 160 degrees and the second stroke cylinder implementing a further additional pivotal range of about 120 degrees. That therefore avoids having to overcome the dead point of a stroke cylinder as neither of the two stroke cylinders has to be extended as far as its dead point. In that way the working ranges are sharingly allocated to the two stroke cylinders. The disadvantage of this method is that it involves an increased expenditure on material and thus increased costs as an intermediate member and two powerful stroke cylinders are necessary to achieve a pivotal range for the two crane arms, which is greater than 180 degrees.

The object of the invention is to avoid the above-described disadvantages and to provide a crane which is improved in relation to the state of the art and in which the dead point of the piston-cylinder unit relative to the joint is overcome.

In the crane according to the invention that object is attained in that there is provided at least one further drive by which it is possible to go beyond the dead point position of the piston-cylinder unit relative to the joint.

In other words that further drive provides that a piston-cylinder unit which is in the region of the dead point position—strictly speaking the dead point occurs when the force vector of the piston-cylinder unit is in a line with the joint between the first crane arm and the second crane arm—is moved out of that dead point position and thus the piston-cylinder unit again provides for the further pivotal movement of the two crane arms relative to each other. Accordingly the pivotal movement of the two crane arms—apart from the region of the dead point position—takes place over the entire range of approximately 360 degrees with one and the same piston-cylinder unit. The further drive is required exclusively in the region of the dead point position of the two crane arms and thus only has to be so powerful that its force is sufficient to overcome the dead point. The further drive does not have to be so designed to further pivot the two crane arms as, after the dead point has been overcome, the piston-cylinder unit again takes over performing the pivotal movement, so it could thus be viewed as an auxiliary drive. The previous construction of a crane—in contrast to the crane disclosed in DE 69 16 283—can be retained, no major modifications are necessary, the crane arms are only additionally equipped with a further drive. It is thus also possible for existing cranes to be subsequently equipped with such a further drive to overcome a dead point position of the piston-cylinder unit. The amount of space required during the inward pivotal movement is minimised as there is no need for the opened crane arms to be supported against the underlying ground and that can equally be effected in the lifted condition of the crane arms, which is a great advantage in particular in a tight space as between houses, on building sites and in woods etc. It should be noted in that respect that it is naturally also possible to so design the piston-cylinder unit that for example two substantially parallel piston-cylinder units are used, which acting symmetrically in the same direction move the two crane arms relative to each other. Using a further drive means that there is also no reliance on an additional joint or intermediate member between the two crane arms and the piston-cylinder unit to permit a pivotal movement beyond the dead point region.

Further advantageous embodiments of the invention are defined in the appendant claims.

Preferably the further drive includes a linear drive, in that case it is particularly advantageous if the linear drive has a piston-cylinder unit as that both permits a small structural configuration and can also be protected well from environmental influences.

Preferably the further drive is provided with a pulling means which extends from the underside of the first crane arm past the joint to the top side of the second crane arm and thereby permits good transmission of force while requiring a small amount of space. A chain is also particularly advantageous here as the pulling means, while it will be appreciated that belts, cables and other movable pulling means are also possible.

In accordance with a preferred embodiment it can be provided that the further drive is caused to act by way of a releasable coupling device as that permits small structural sizes and thus the folding-together movement is not limited by linkages, hinge joints or the like. Thus for example the first coupling portion can be in the form of a receiving device and the received second coupling portion can be provided on the further drive. Preferably the releasable coupling device can also be provided with a lever as that permits improved transmission of force.

It has proven to be particularly advantageous in that respect if the further drive is provided in the interior of one of the two crane arms as that therefore means that no space is taken up at the outside of one of the two crane arms and this therefore ensures maximum space saving and maximum capability for the arms to be folded together.

Preferably the crane arms are telescopic as that makes it possible to achieve greater radii of action.

In accordance with a preferred configuration it can be provided that the crane is equipped with a control device which triggers automatic switching-over of the operative direction of the piston-cylinder unit so that manual switching-over is not required. Preferably that switching-over process is performed by a switching device having a switching valve which operates as a limit switch which at the switching point causes reversal of the piston-cylinder unit. It will be appreciated that as the switching device it is equally possible to consider any other technical option which can trigger a switching process, such as for example a sensor or a light barrier arrangement or the like.

In accordance with a preferred configuration it can be provided that the further drive is so arranged on the crane arm that the dead point position of the piston-cylinder unit occurs at a different joint position from the dead point position of the piston-cylinder unit of the further drive. It is thus possible for a piston-cylinder unit to move the other piston-cylinder unit out of the dead point position thereof.

It has proven to be particularly advantageous in that respect if the piston-cylinder units of the drives are so designed that they are substantially equivalent and the arrangement thereof relative to each other is substantially parallel at the sides of the first crane arm and asymmetrical at the sides of the second crane arm.

As a particularly suitable area of use it can be provided that the crane is in the form of a Z-crane having a rotatably mounted vertical crane mast, a lift arm pivotably mounted thereto and at least one bending arm rotatably hingedly connected to the lift arm. Hereinafter by way of example the lift arm is referred to as the first crane arm and the bending arm as the second crane arm, but that is not to be considered as a limitation.

In specific terms such a crane can be used on a vehicle.

Further details and advantages of the present invention will be described more fully hereinafter by means of the specific description with reference to the embodiments by way of example illustrated in the drawing in which:

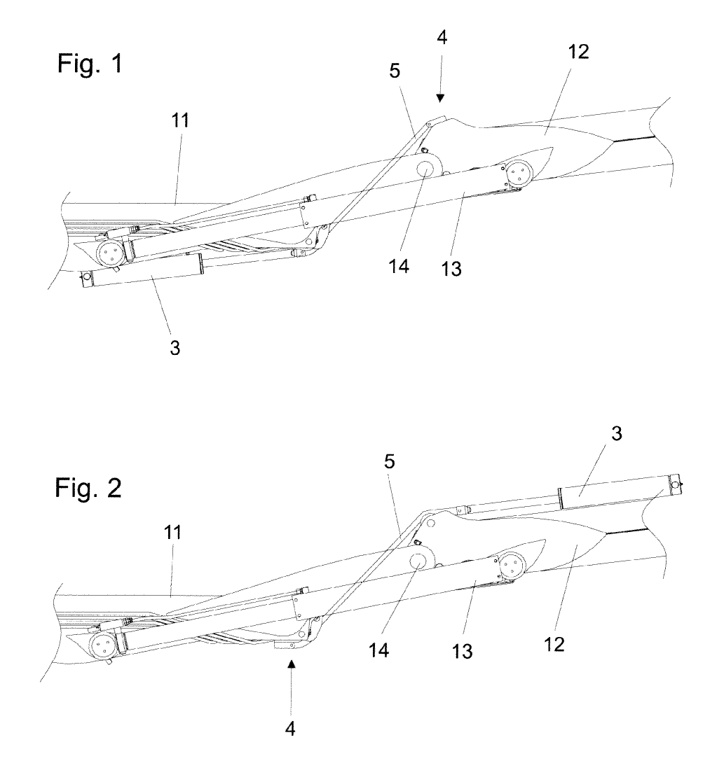

FIGS. 1 through 8 show 8 diagrammatic views of embodiments of an arrangement according to the invention,

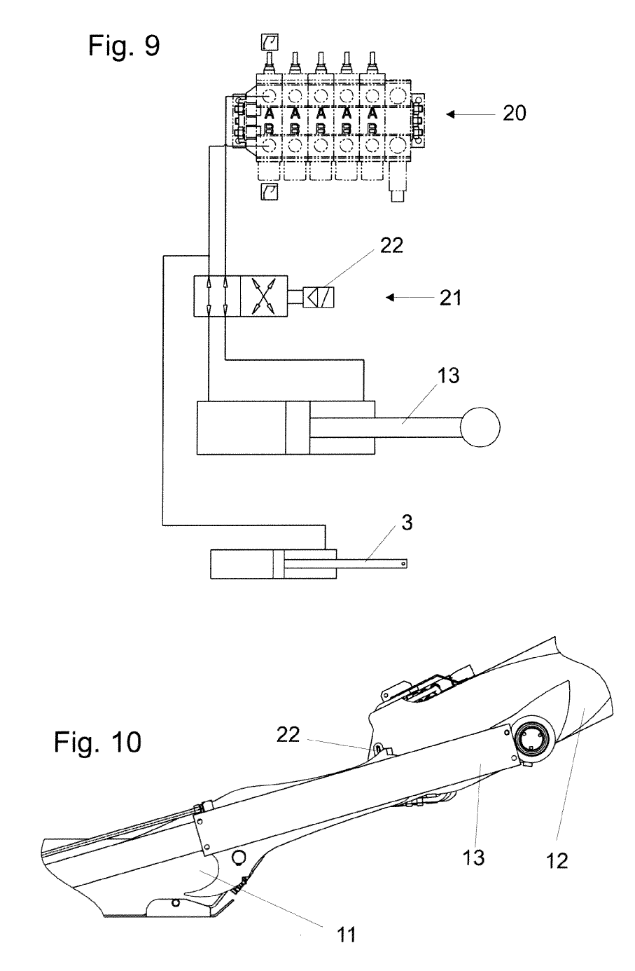

FIGS. 9 through 11 show diagrammatic views of the control and switching device, and

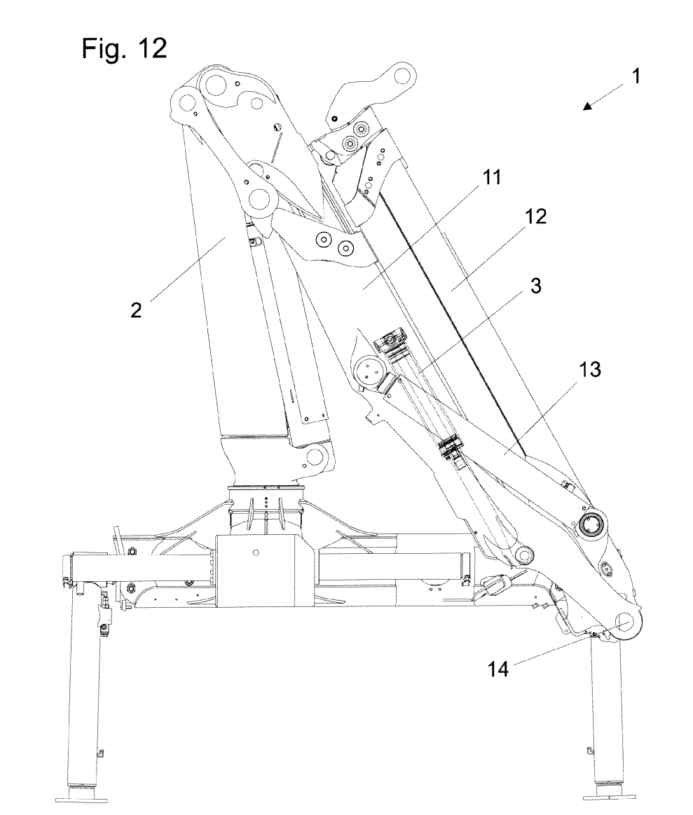

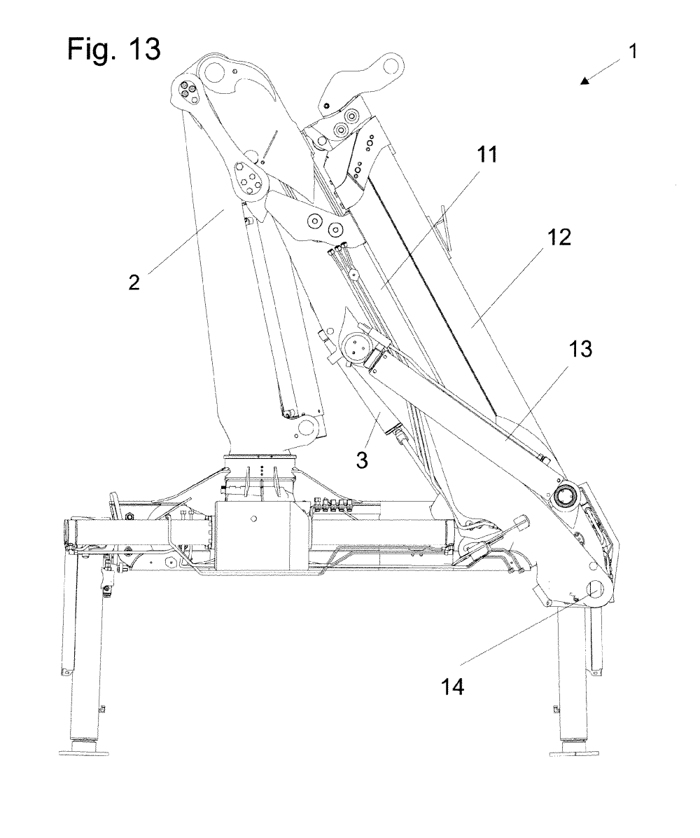

FIGS. 12 and 13 show a Z-crane in the parking position (folded together).

FIG. 1 shows a first crane arm 11 hingedly connected to a second crane arm 12 by way of the joint 14. Mounted at the underside of the first crane arm 11 is the further drive which has a piston-cylinder unit 3. The piston-cylinder unit 3 is connected by way of a chain 5 to the second crane arm 12. The pivotal extension movement takes place as usual—without the assistance of the further drive —, the piston-cylinder unit 13 extends the second crane arm 12 until the piston-cylinder unit 13 passes into the region of the dead point (when the longitudinal axis of the piston-cylinder unit 13 and the joint 14 extend in a line). By virtue of the force of gravity the dead point position is overcome and the piston-cylinder unit 13 can retract and move the second crane arm 12. For the inward pivotal movement of the second crane arm 12 the piston-cylinder unit 13 extends until it passes into the region of its dead point. The piston-cylinder unit 3 of the further drive now comes in, the chain 5 moves the second crane arm 12 and the piston-cylinder unit 13 in so doing moves beyond its dead point position. The piston-cylinder unit 13 then retracts until the two crane arms reach their end position, the parking position.

FIG. 2 shows a variant of FIG. 1 in which the piston-cylinder unit 3 of the further drive is fixed at the underside of the second crane arm 12. The path of the chain 5 of the further drive is equally from the underside of the first crane arm 11 to the top side of the second crane arm 12. The mode of operation involved in the inward pivotal movement is accordingly identical to the description of FIG. 1.

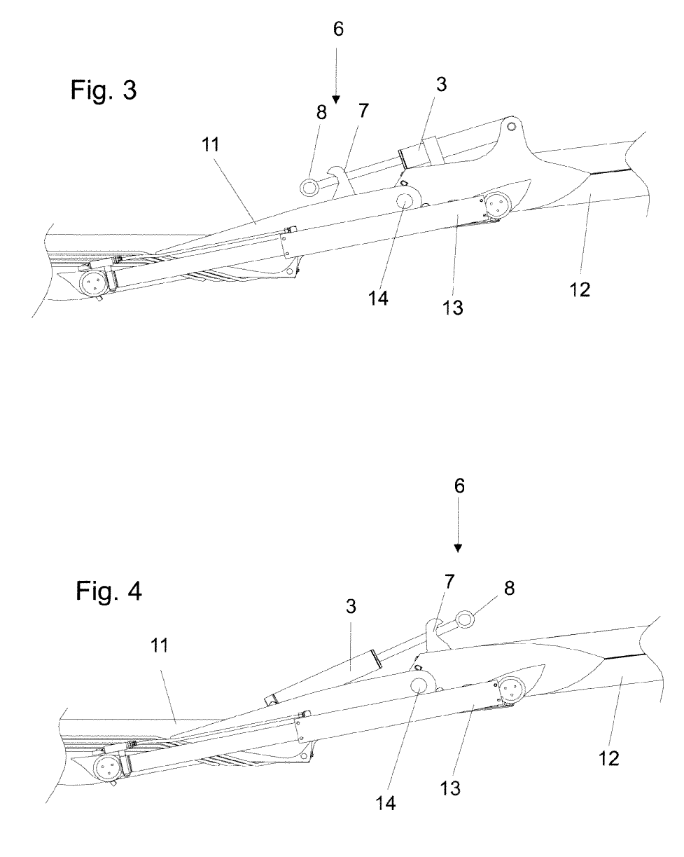

FIG. 3 shows a releasable coupling device 6 in which a first coupling portion 7 which is in the form of a catching receiving device is fixed to the first crane arm 11 and the second coupling portion 8 is mounted to the piston-cylinder unit 3 of the further drive. In the region of the dead point position of the piston-cylinder unit 13 the piston-cylinder unit 3 of the further drive retracts and the second coupling portion 8 engages into the first coupling portion 7 and thus provides that the second crane arm 12 is folded upwardly and the piston-cylinder unit 13 is moved out of its dead point position. The piston-cylinder unit 13 then retracts until the two crane arms reach their end position, the parking position, in which case the two coupling portions 7 and 8 have separated from each other again during the retraction movement.

FIG. 4 shows a variant of FIG. 3 in which the piston-cylinder unit 3 of the further drive is on the first crane arm 11 and the first coupling portion 7, also in the form of a catching receiving device, is on the second crane arm 12. The mode of operation of the inward pivotal process is in substance identical to the description of FIG. 3.

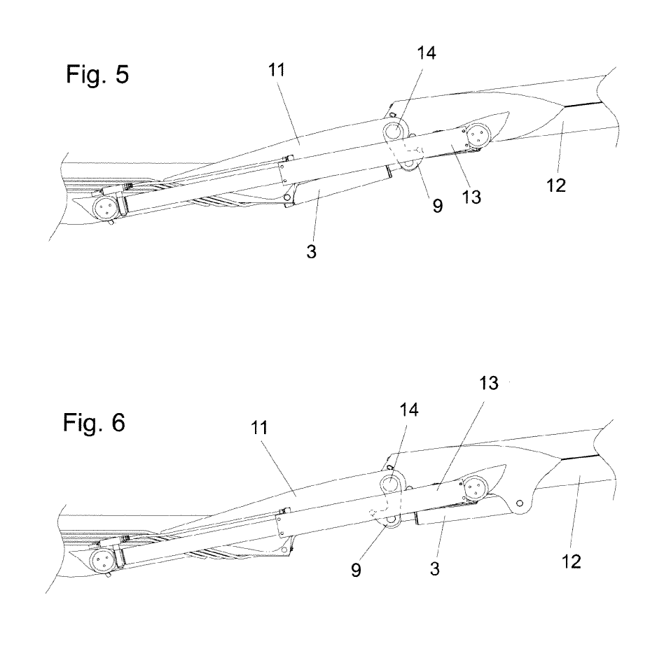

FIG. 5 shows how the piston-cylinder unit 3 of the further drive, which is on the first crane arm 11, presses against a lever 9 which is on the second crane arm 12 and thus can overcome the dead point position of the piston-cylinder unit 13 relative to the joint 14. The procedure involved in the inward pivotal movement is in substance identical to the preceding illustrated examples.

FIG. 6 shows a variant of FIG. 5 in which the piston-cylinder unit 3 of the further drive is on the second crane arm 12 and the lever 9 is on the first crane arm 11. The procedure involved in the inward pivotal movement is in substance identical to the preceding illustrated examples.

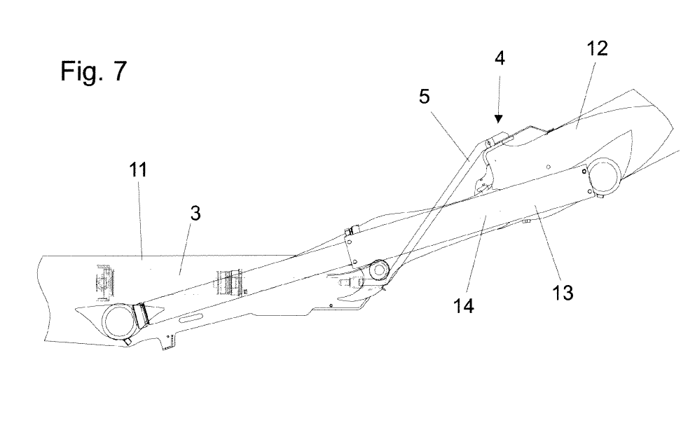

FIG. 7 shows a variant of FIG. 1 in which the further drive is in the interior of the first crane arm 11 and is not at the outside of one of the two crane arms. That therefore affords the maximum saving of space. The mode of operation of the inward pivotal movement is identical to the description relating to FIG. 1.

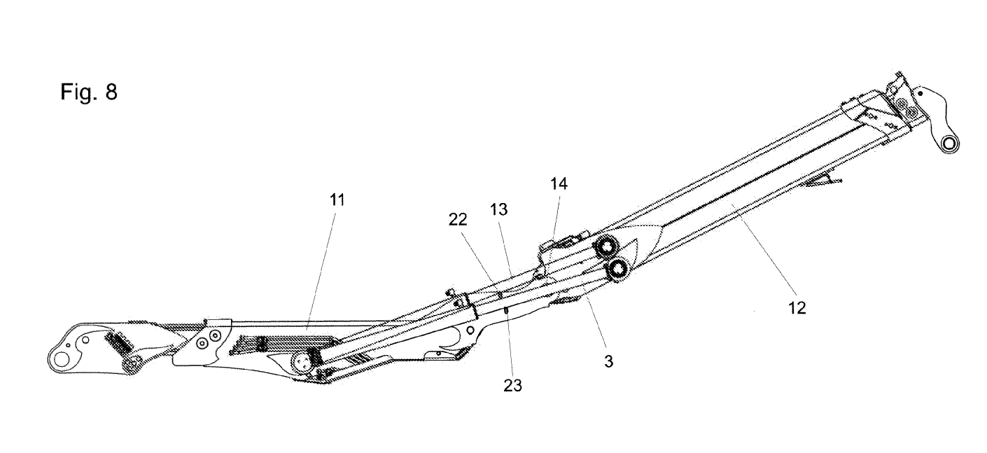

FIG. 8 shows an asymmetrical arrangement of the piston-cylinder unit 13 relative to the piston-cylinder unit 3 of the further drive from the first crane arm 11 to the second crane arm 12, wherein the piston-cylinder unit 13 is mounted on the left-hand side of the crane arms and the piston-cylinder unit 3 of the further drive is mounted on the right-hand side of the crane arms. For the sake of improved clarity of the drawing FIG. 8 visibly shows both piston-cylinder units so that the differences can be better perceived. In that case the piston-cylinder unit 3 of the further drive is pivotably mounted at a different lower position on the crane arm 12 than the piston-cylinder unit 13, thus providing that the dead point position of the respective piston-cylinder unit occurs at a differing position in respect of the joint 14. For inward pivotal movement of the second crane arm 12 both the piston-cylinder unit 13 and also the piston-cylinder unit 3 of the further drive extend until the piston-cylinder unit 13 passes into the region of its dead point. In that case the piston-cylinder unit 3 of the further drive has not yet reached its dead point and is further extended and thus provides that the piston-cylinder unit 13 overcomes its dead point. The two piston-cylinder units then retract until the two crane arms reach their end position, the parking position.

FIG. 9 shows a control device 20 which by way of the switching device 21 causes the piston-cylinder unit 13 to perform a directional reversal in respect of its operative direction. That directional reversal is triggered by the switching valve 22 which functions as a limit switch.

FIG. 10 shows the two outwardly folded crane arms of a crane and a switching valve 22 which in the region of the dead point position of the piston-cylinder unit 13 relative to the joint 14 causes the control device 20 to implement a directional reversal in the operative direction of the piston-cylinder unit 13. Thus there is no need for manual counteracting control or for switching-over by the operator and the two crane arms retract to their end position, the parking position.

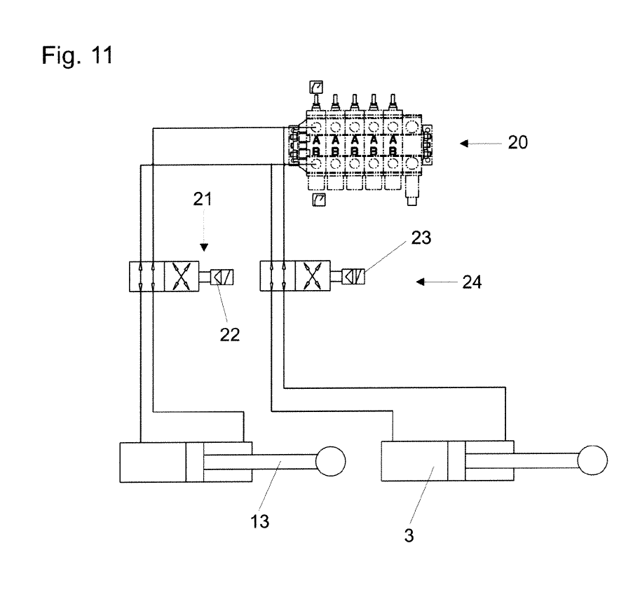

FIG. 11 shows a control device 20 which by way of the switching device 21 causes the piston-cylinder unit 13 to perform a directional reversal in respect of its operative direction. That directional reversal is triggered by the switching valve 22 (see in that respect also FIG. 8). In addition the piston-cylinder unit 3 is caused by way of the switching device 24 to perform a directional reversal in respect of its operative direction. That directional reversal is triggered by the switching valve 23 (see in that respect also FIG. 8).

FIG. 12 shows a folded-together Z-crane 1 comprising a crane mast 2 and two crane arms. In this case the piston-cylinder unit 3 of the further drive is in the interior of the first crane arm 11.

FIG. 13 also shows a folded-together Z-crane 1 (parking position) in which the piston-cylinder unit 3 of the further drive is mounted externally to the first crane arm 11.

Even if the invention has been described in specific terms by means of the illustrated embodiment it will be appreciated that the subject-matter of the application is not limited to that embodiment. Rather it will be appreciated that measures and modifications which serve to implement the concept of the invention are certainly conceivable and desired.

### LIST OF REFERENCES

1 Z-crane
2 crane mast
3 piston-cylinder unit of the further drive
4 pulling point of the chain 5
5 chain
6 coupling device
7 first coupling portion
8 second coupling portion
9 lever
11 first crane arm
12 second crane arm
13 piston-cylinder unit
14 joint
20 control device
21 switching device of the piston-cylinder unit 13
22 switching valve of the switching device 21
23 switching valve of the switching device 24
24 switching device of the piston-cylinder unit 3

1. A crane, in particular a vehicle crane,
comprising a first crane arm and at least one second crane arm
which are connected together by way of a joint and
which are pivotable relative to each other by way of a drive having a piston-cylinder unit, in each case starting from one of the two end positions in which the crane arms are in substantially mutually parallel relationship until reaching a dead point when the longitudinal axis of the piston-cylinder unit is substantially on a line with the joint,
wherein there is provided at least one further drive by which it is possible to go beyond the dead point position of the piston-cylinder unit relative to the joint.

2. A crane as set forth in claim 1 the further drive includes a linear drive.

3. A crane as set forth in claim 2 wherein the linear drive has at least one piston-cylinder unit.

4. A crane as set forth in claim 1 wherein the further drive has a pulling means which when crane arms are substantially straight extends from the underside of the first crane arm to the top side of the second crane arm.

5. A crane as set forth in claim 4 wherein the pulling means is a chain.

6. A crane as set forth in claim 1 wherein the further drive is operatively connected by way of a releasable coupling device to the first crane arm or the second crane arm at least in the region of the dead point.

7. A crane as set forth in claim 6 wherein the coupling device has a first coupling portion which is mounted to the first crane arm and which is coupled—at least in the region of the dead point—to a corresponding second coupling portion mounted to the second crane arm and outside the region of the dead point is released from said second coupling portion.

8. A crane as set forth in claim 7 wherein the coupling device has at least one lever.

9. A crane as set forth in claim 1 wherein the further drive is arranged at least region-wise and preferably substantially completely in the interior of the first crane arm or the second crane arm.

10. A crane as set forth in claim 1 wherein at least one of the crane arms is telescopic.

11. A crane as set forth in claim 1 wherein there is provided a control device by which the piston-cylinder unit experiences switching-over of the operative direction of the piston-cylinder unit at a given angle of the first crane arm relative to the second crane arm.

12. A crane as set forth in claim 11 wherein there is provided at least one switching device, the signals of which can be passed to the control device.

13. A crane as set forth in claim 12 wherein the switching device has a switching valve by which the operative direction of the piston-cylinder unit can be reversed when the switching point is reached.

14. A crane as set forth in claim 1 wherein the joint position of the two crane arms, at which the dead point position of the piston-cylinder unit relative to the joint occurs, differs from the joint position at which the dead point position of the piston-cylinder unit of the further drive relative to the joint occurs.

15. A crane as set forth in claim 1 wherein the piston-cylinder unit and the piston-cylinder unit of the further drive are pivotably mounted asymmetrically to at least one of the two crane arms.

16. A crane as set forth in claim 1 wherein the crane is in the form of a Z-crane.

17. A vehicle having a crane as set forth in claim 1.
